(19) United States
(12) Patent Application Publication
(10) Pub. No.: US 2009/0092811 A1
(43) Pub. Date: Apr. 9, 2009

(54) COMPRESSIBLE COATING LAYERS

(75) Inventors: Anthony M. Chasser, Allison Park, PA (US); Constantine A. Kondos, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc, Cleveland, OH (US)

(21) Appl. No.: 11/869,253

(22) Filed: Oct. 9, 2007

(51) Int. Cl. B32B 27/40; B32B 5/16; C08G 71/04

(52) U.S. Cl. 428/220; 428/327; 428/423.1; 524/612

(57) ABSTRACT

A compressible coating layer comprising a film forming resin and a thermoplastic additive is disclosed. The film forming resin comprises polyurea and/or polyurethane and the thermoplastic additive comprises a micronized amide wax. The thermoplastic additive is dispersed throughout the coating and maintains separate phase domains upon cure. Methods for coating substrates using these compressible coating layers and substrates coated thereby are also disclosed.

### FIELD OF THE INVENTION

The present invention is directed to compressible coating layers comprising a film forming resin and a thermoplastic additive dispersed throughout the film forming resin wherein the resin and the additive maintain separate phase domains upon cure, and wherein the film forming resin comprises polyurea and/or polyurethane and the thermoplastic additive comprises micronized amide wax.

### BACKGROUND OF THE INVENTION

There are numerous coatings used throughout various industries to impart a protective and/or decorative layer to a substrate. These coatings will typically have various properties in a desired range such as hardness, softening point (“Ts”), glass transition temperature (“Tg”), mar and scratch resistance, corrosion resistance, and the like; the particular properties desired for a coating will vary depending on the type of coating and the application. Properties can be altered for example, through the use of different resins, crosslinkers and additives. The use of an additive to improve one property, however, can have a detrimental effect on another property. Thus, a balancing between properties is typically done to achieve the best coating for a particular purpose. Tools to assist in this balancing are always desired.

### SUMMARY OF THE INVENTION

The present invention is directed to a compressible coating layer comprising a film forming resin and a thermoplastic additive dispersed throughout the film forming resin, wherein the resin and the additive maintain separate phase domains upon cure, and wherein the film forming resin comprises polyurea and/or polyurethane and the thermoplastic additive comprises micronized amide wax. The present invention is further directed to methods for applying such coatings and articles comprising such coatings.

### DETAILED DESCRIPTION OF THE INVENTION

The present invention is directed to a compressible coating layer comprising a film forming resin and a thermoplastic additive dispersed throughout the film forming resin. The resin and additive maintain separate phase domains upon cure. The term “compressible” is used herein to refer to a coating layer that can be compressed, at least somewhat, upon application of a force (“compressive force”) and that will return to its substantially original state upon release of the compressive force. It will be understood by those skilled in the art that for a coating layer to be compressible it needs to have some degree of thickness. In certain embodiments, the compressible coating layer described herein has a dry film thickness of 8 mils or greater, such as 10 mils or greater, 100 mils or greater, or 1000 mils or greater.

The film forming resin of the compressible coating layer of the present invention comprises a polyurea and/or a polyurethane. The compressible coating layer is thermosetting. In certain embodiments, other thermosetting coating components can be used in addition to polymer and/or polyurethane. In certain embodiments, the film forming resin consists essentially of polyurea and/or polyurethane. The coating composition(s) may be water-based or solvent-based liquid compositions, 100% solids, or, alternatively, in solid particulate form, i.e., a powder coating; the coatings can be curable by any means and in any manner known in the art, such as heat cure, ambient cure, UV cure, and the like. One skilled in the art can determine the appropriate curing means based upon the particular coating formulation. In certain embodiments, the coating layer is a nonemissive coating. A “nonemissive coating” refers to a coating, the components of which do not form a byproduct upon reaction. It will be understood by those skilled in the art that solvent emission during cure is not regarded as a “byproduct”. Thus, a coating formulation that gives off solvent during cure can still be “nonemissive”.

Polyureas are generally formed by reacting amines and isocyanates, and polyurethanes from a reacting hydroxyl group containing compounds, such as polyols, with isocyanates.

As used herein, the term “isocyanate” includes unblocked compounds capable of forming a covalent bond with a reactive group such as a hydroxyl, mercaptan or amine functional group. Thus, isocyanate can refer to “free isocyanate”, which will be understood to those skilled in the art. In alternate non-limiting embodiments, the isocyanate can be monofunctional containing one isocyanate functional group (NCO) or the isocyanate can be polyfunctional containing two or more isocyanate functional groups (NCOs).

Suitable isocyanates for use in certain embodiments of the present invention are numerous and can vary widely. Such isocyanates can include those that are known in the art. Non-limiting examples of suitable isocyanates can include monomeric and/or polymeric isocyanates. The polyisocyanates can be selected from monomers, prepolymers, oligomers, or blends thereof. In an embodiment, the polyisocyanate can be C₂-C₂₀ linear, branched, cyclic, aromatic, or blends thereof.

Suitable isocyanates for use in the present invention may include but are not limited to isophorone diisocyanate (IPDI), which is 3,3,5-trimethyl-5-isocyanato-methyl-cyclohexyl isocyanate; hydrogenated materials such as cyclohexylene diisocyanate, 4,4′-methylenedicyclohexyl diisocyanate (H₁₂MDI); mixed aralkyl diisocyanates such as tetramethylxylyl diisocyanates, OCN—C(CH₃)₂—C₆H₄C(CH₃)₂—NCO; polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate and 2-methyl-1,5-pentamethylene diisocyanate; and mixtures thereof.

Non-limiting examples of aromatic isocyanates for use in the present invention may include but are not limited to phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, alkylated benzene diisocyanates, methylene-interrupted aromatic diisocyanates such as methylenediphenyl diisocyanate, 4,4′-isomer (MDI) including alkylated analogs such as 3,3′-dimethyl-4,4′-diphenylmethane diisocyanate, polymeric methylenediphenyl diisocyanate and mixtures thereof.

In a non-limiting embodiment, polyisocyanate monomer may be used. It is believed that the use of a polyisocyanate monomer (i.e., residual-free monomer from the preparation of prepolymer) may decrease the viscosity of the coating composition thereby improving its flowability, and may provide improved adhesion of the coating to a previously applied coating and/or to an uncoated substrate. For example, the coatings that have been previously applied to a substrate can comprise functional groups (e.g. hydroxy groups) that are reactive with isocyanates, thereby enhancing adhesion of this coating to the compressible coating composition of the present invention applied over this coating. A lower viscosity polyurea/polythiourea composition may also remain in a “flowable” state for a longer period of time as compared to a comparable composition having a higher viscosity. In alternate embodiments of the present invention, at least 1 percent by weight, or at least 2 percent by weight, or at least 4 percent by weight of the isocyanate component comprises at least one polyisocyanate monomer.

The isocyanate can also include oligomeric polyisocyanates including but not limited to dimers, such as the uretdione of 1,6-hexamethylene diisocyanate, trimers, such as the biuret and isocyanurate of 1,6-hexanediisocyanate and the isocyanurate of isophorone diisocyanate, allophonates and polymeric oligomers. Modified polyisocyanates can also be used, including but not limited to carbodiimides and uretdiones, and mixtures thereof. Suitable materials include, without limitation, those available under the designation DESMODUR from Bayer Corporation of Pittsburgh, Pa. and include DESMODUR N 3200, DESMODUR N 3300, DESMODUR N 3400, DESMODUR XP 2410, and DESMODUR XP 2580.

As used herein, “isocyanate prepolymer” includes polyisocyanate that is pre-reacted with a polyamine, sulfur-containing compound having a reactive group and/or another isocyanate reactive group such as polyol. Suitable polyisocyanates include those previously disclosed herein. Suitable polyamines are numerous and may be selected from a wide variety known in the art. Examples of suitable polyamines include but are not limited to primary and secondary amines, and mixtures thereof, such as any of those listed herein. Amine terminated polyureas may also be used. Amines comprising tertiary amine functionality can be used provided that the amine further comprises at least two primary and/or secondary amino groups. Suitable polyols are numerous and may be selected from a wide variety known in the art. Examples of suitable polyols include but are not limited to polyether polyols, polyester polyols, polyurea polyols (e.g. the Michael reaction product of an amino function polyurea with a hydroxyl functional (meth)acrylate), polycaprolactone polyols, polycarbonate polyols, polyurethane polyols, poly vinyl alcohols, addition polymers of unsaturated monomers with pendant hydroxyl groups such as those containing hydroxy functional (meth)acrylates, allyl alcohols and mixtures thereof.

In certain embodiments, the isocyanate includes an isocyanate prepolymer and in other embodiments the isocyanate includes an isocyanate prepolymer and one or more additional isocyanates, such as one or more of the polyisocyanates described above.

Suitable amines for use in the present invention can be selected from a wide variety of known amines, such as primary and secondary amines, and mixtures thereof including polyamines having at least two functional groups, such as di-, tri-, or higher functional polyamines and mixtures thereof. The amine or amines used may be aromatic or aliphatic, such as cycloaliphatic, or mixtures thereof. Suitable monoamines include but are not limited to primary amines of the formula R—NH₂, where R is a hydrocarbon radical that may represent a straight chain or branched alkyl group, an aryl-alkyl group, a hydroxyalkyl group or an alkoxyalkyl group. Other examples of suitable aliphatic mono and polyamines include but are not limited to ethylamine, isomeric propylamines, butylamines (e.g. butylamine, isobutylamine, sec-butylamine, and tert-butylamine), pentylamines, hexylamines, cyclohexylamine, ethylene diamine, 1,2-diaminopropane, 1,4-diaminobutane, 1,3-diaminopentane (DYTEK EP, Invista), 1,6-diaminohexane, 2-methyl-1,5-pentane diamine (DYTEK A, Invista), 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′-diaminodicyclohexyl methane, 4,4′-diaminodicyclohexyl methane (PACM-20, Air Products) and 3,3′-dialkyl-4,4′-diaminodicyclohexyl methanes (such as 3,3′-dimethyl-4,4′-diaminodicyclohexyl methane (DIMETHYL DICYKAN or LAROMIN C260, BASF; ANCAMINE 2049, Air Products) and 3,3′-diethyl-4,4′-diaminodicyclohexyl methane), 2,4- and/or 2,6-diaminotoluene and 2,4′- and/or 4,4′-diaminodiphenyl methane, or mixtures thereof. Additional suitable amines include but are not limited to 2-ethylhexylamine, octylamine, tert-octylamine, dodecylamine, octadecylamine, 3-(cyclohexylamine)propylamine, 3,3′-[1,4-butanediylbis]-1-propanamine, and diamino functional polyetheramines having aliphatically bound primary amino groups, examples of which include JEFFAMINE D-230, JEFFAMINE D-400, JEFFAMINE D-2000, and JEFFAMINE D-4000 available from Huntsman Corporation. It will be appreciated that when the amine is hindered, the reaction time between the amine and the isocyanate may be slower. This gives a longer pot-life or work-processing time in those situations where a longer processing time is desired.

In certain embodiments the polyamine is a triamine. Examples of suitable triamines include dipropylene triamine, bis(hexamethylene) triamine and triamino functional polyetherpolyamines having aliphatically bound primary amino groups (JEFFAMINE T-403, JEFFAMINE T-3000, JEFFAMINE T-5000 from Huntsman Corporation.) In other embodiments the amine can be a tetraamine or other higher functional amine.

The amine may comprise an amine/(meth)acrylate oligomeric reaction product, and/or one or more other amine curatives. As used herein, and as will be appreciated by those skilled in the art, “(meth)acrylate” and like terms refers to both the acrylate and the corresponding methacrylate. For example, the amine may comprise one or more amines that are the reaction product of a polyamine, a poly(meth)acrylate, and a mono(meth)acrylate or a monoamine, such as those described in U.S. patent application Ser. No. 11/611,979, incorporated by reference herein; one or more amines that are the reaction product of an amine, a (meth)acrylate and a dialkyl maleate and/or dialkyl fumarate, such as those described in U.S. patent application Ser. No. 11/611,988, incorporated by reference herein; one or more amines that are the reaction product of a polyamine and a mono(meth)acrylate, such as those described in U.S. patent application Ser. No. 11/611,982, incorporated by reference herein; one or more amines that are the reaction product of a monoamine and a (meth)acrylate, such as those described in U.S. patent application Ser. No. 11/611,984, incorporated by reference herein; and/or one or more amines that are the reaction product of a triamine and a dialkyl maleate and/or dialkyl fumarate, such as those described in U.S. patent application Ser. No. 11/611,986, incorporated by reference herein.

The present compositions can additionally include other amines, such as those known in the art including but not limited to any polyamines or combinations thereof listed herein. Other amines include secondary cycloaliphatic diamines such as JEFFLINK 754 (Huntsman Corporation, Houston, Tex.) and CLEARLINK 1000 (Dorf-Ketal Chemicals, LLC), aspartic ester functional amines, such as those available under the name DESMOPHEN such as DESMOPHEN NH1220, DESMOPHEN NH 1420, and DESMOPHEN NH 1520 (Bayer Corporation), other aspartic ester functional materials, such as the reaction products of triamines that comprise at least one secondary amino group prior to reaction with a dialkyl maleate and/or dialkyl fumarate including but not limited to the reaction products of diethylene triamine, dipropylene triamine, and bis-hexamethylene triamine with a dialkyl maleate and/or dialkyl fumarate; examples of such materials include the adduct of dipropylene triamine and diethyl maleate, the adduct of dipropylene triamine and dibutyl maleate, the adduct of bis-hexamethylene triamine with diethyl maleate, and the adduct of bis-hexamethylene triamine with dibutyl maleate. Polyoxyalkyleneamines are also suitable. Polyoxyalkyleneamines comprise two of more primary or secondary amino groups attached to a backbone, derived, for example, from propylene oxide, ethylene oxide, butylene oxide or a mixture thereof. Examples of such amines include those available under the designation JEFFAMINE, such as, without limitation, JEFFAMINE D-230, D-400, D-2000, HK-511, ED-600, ED-900, ED-2003, T-403, T-3000, T-5000, SD-231, SD-401, SD-2001, and ST-404 (Huntsman Corporation). Such amines have an approximate molecular weight ranging from 200 to 7500.

Other suitable secondary amines that can be included in the present composition are reaction products of materials comprising primary amine functionality with acrylonitrile. Suitable amines include any polyamine listed herein comprising primary amino functionality. One example of such a material is the adduct of 4,4′-diaminodicyclohexylmethane and acrylonitrile. An example of a commercially available material is the adduct of isophorone diamine and acrylonitrile sold under the designation POLYCLEAR 136, (Hansen Group LLC).

Other amines that can be used are adducts of primary polyamines with mono or polyepoxies; an example of such a material is the adduct of isophorone diamine with CARDURA E10P (available from Hexion Speciality Chemicals, Inc).

Suitable hydroxy-containing compounds for use in the present invention can be selected from a wide variety of known compounds such as polyols; that is, compounds having two or more hydroxy groups.

In certain embodiments, the coating comprises polyurea, and the isocyanate component and amine component used to form the polyurea may be combined such that the ratio of equivalents of isocyanate groups to equivalents of amine groups is greater than 1 and the isocyanate component and the amine component can be applied to a substrate at a volume mixing ratio of 1:1; the reaction mixture may be applied to an uncoated or coated substrate to form a first coating on the uncoated substrate or a subsequent coating on the coated substrate. When determining the ratio of equivalents of isocyanate groups to equivalents of reactive amine groups, the total amine groups are taken into consideration; that is the amine groups from any amine or amines used in the coating.

If desired, the coating composition used to form the coating layer can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, flame retardants, such as those disclosed in U.S. patent application Ser. No. 11/460,439, incorporated by reference herein, adhesion promoters, such as those disclosed in U.S. patent application Ser. No. 11/591,312, incorporated by reference herein, organic cosolvents, reactive diluents catalysts, including phosphonic acids and other customary auxiliaries. If plasticizers, fillers, and/or pigments are used, their effect, if any, on the compressibility and/or bulk hardness of the coating should be considered.

The thermoplastic additives used according to the present invention can be any micronized amide wax that maintains separate phase domains in the coating upon cure of the coating. The ability to maintain separate phase domains means that the additives will substantially maintain their form and/or their integrity, even after cure. Moreover, the additives are dispersed throughout the coating, and again such dispersion is maintained even after cure. Thus, the coating layer is non-homogenous, that is, the additives do not “melt” or flow to any significant degree. The additives can be dispersed substantially evenly throughout the coating, or can be concentrated in the coating, such as at the surface, the bottom or any other portion of the coating. In certain embodiments, the thermoplastic additive has a high melting point. By high melting point is meant ≧45° C., such as ≧50° C., ≧80° C., ≧100° C., and up to 200° C. In certain embodiments, the melting point is 140 to 150° C. Suitable micronized amide wax is commercially available, for example, from Byk-Chemie as CERAFLOUR 994. The molecular weight and/or size of the thermoplastic micronized amide wax can vary widely and do not generally have a significant impact on the compressibility of the coating, although typically the larger the size of the additive the greater the compression. The average size of the additive typically will be less than the thickness of the coating. Stated another way, in certain embodiments the coating will be thick enough that the additive does not protrude.

In addition to micronized amide wax, one or more additional thermoplastic additives can be used. The average particle size can be, for example 1 μm or greater, 4 μm or greater or 12 μm or greater. The additives can be in the form of beads, such as polyamide beads, commercially available from King Industries, and Lubrizol, compressible microspheres, such as polymethyl(meth)acrylate microspheres, commercially available from Byk-Chemie, polyethylene, polypropylene, and/or polystyrene beads from Dow Chemical and Exxon, polyvinylchloride beads from Air Products, polyethylene terephthalate (“PET”) pellets from Eastman, or can be in any other form. The additives can comprise polyamides, acrylates, such as polymethyl(meth)acrylates, polyethylenes, polypropylenes, polyvinylidenes, polystyrene, polytetrafluoroethylene (“PTFE”) such as that commercially available under the names KYNAR and TEFLON, PTFE modifications, polyvinylbutyral, PET, and/or polyethylene/polypropylene copolymers. In certain embodiments, the additive can be one that will leach out into the environment; for example, the additive could be one that imparts antimicrobial properties to the coating.

It is a significant achievement of the present invention that a compressible coating layer can be achieved while maintaining a surface or bulk hardness in Shore D of 50 or greater. Shore D is measured by methods standard in the art. It is a further significant achievement of the present invention that a compressible coating layer with this Shore D can be achieved while also achieving thermal stability of the coating. By thermal stability is meant that the coating, once cured, won't flow at high temperatures (for example ≧120° C.). Thus, the coating compositions used to form the compressible coating layers of the present invention are ductile or “rubbery” at use temperatures (for example, −20 to 120° C.), but maintain their integrity at temperatures greater than 120° C. It has been surprisingly discovered that the use of the thermoplastic additives according to the present invention can change the bulk hardness of the coating layer without changing the compressibility of the layer. This is a surprisingly result because typically additives, such as pigments, that are used to increase the hardness will also increase the softening point (or compressibility) of the coating, while additives, such as plasticizers, typically added to decrease the compressibility or softening point, will also decrease the hardness coating with the ability to increase hardness without also increasing compressibility and substrates coated thereby is a significant achievement. The Ts of the compressible coating layer of the present invention will typically be >55° C., such as ≧65° C., ≧75° C., or ≧80° C., up to ≦250° C., ≦200° C. or ≦150° C., and within any combination of ranges with these endpoints, such as >65° C. to <250° C.

It will be appreciated that the present compositions are two component or “2K” compositions, wherein the isocyanate component and the amine and/or hydroxy component(s) are kept separate until just prior to application. Such compositions will be understood as curing under ambient conditions, although a heated forced air or a heat cure can be applied to accelerate final cure or to enhance coating properties such as adhesion. Any method known in the art for applying these types of coatings can be used. In an embodiment, the coating composition may be sprayable and may be prepared using a two-component mixing device. In this embodiment, isocyanate component and amine and/or hydroxy component are added to a high pressure impingement mixing device. The isocyanate component is added to the “A-side” and amine component is added to the “B-side”. The A- and B-side streams are impinged upon each other and immediately sprayed onto at least a portion of an uncoated or coated substrate. The isocyanate and the amine and/or hydroxy-containing compound react to produce a coating composition that is cured upon application to the uncoated or coated substrate. The A- and/or B-side can also be heated prior to application, such as to a temperature of 140° F. Heating may promote a better viscosity match between the two components and thus better mixing, but is not necessary for the curing reaction to occur.

It is believed that the ratio of equivalents of isocyanate groups to amine/hydroxy groups may be selected to control the rate of cure of the coating composition of the present invention. It has been found that cure and adhesion advantages may result when applying the coating in a 1:1 volume ratio wherein the ratio of the equivalents of isocyanate groups to amine/thiol groups (also known as the reaction index) is greater than one, such as from 1.01 to 1.10:1, or from 1.03 to 1.10:1, or from 1.05 to 1.08:1 or from 1.01 to 1.4:1 or from 1.01 to 1.5:1, or greater than 1.3:1. For example, good adhesion can be obtained using these ratios over clearcoats that have low surface functionality after cure, such as carbamate melamine, hydroxyl melamine, 2K urethane, and silane-containing clearcoats. The term “1:1 volume ratio” means that the volume ratio varies by up to 20% for each component, or up to 10% or up to 5%.

In a non-limiting embodiment, a commercially available mixing device available commercially under the designation GUSMER VR-H-3000 proportioner fitted with a GUSMER Model GX-7 spray gun may be used. In this device, pressurized streams of the A- and B-side components are delivered from two separate chambers and are impacted or impinged upon each other at high velocity to mix the two components and form a coating composition, which may be applied to an uncoated or coated substrate using the spray gun. The mixing forces experienced by the component streams may depend upon the volume of each stream entering the mixing chamber per unit time and the pressure at which the component streams are delivered. A 1:1 volume ratio of the isocyanate and amine/thiol per unit time may equalize these forces.

Another suitable application device known in the industry includes a “static mix tube” applicator. In this device, the isocyanate component and amine component are each stored in a separate chamber. As pressure is applied, each of the components is brought into a mixing tube in a 1:1 ratio by volume. Mixing of the components is effected by way of a torturous or cork screw pathway within the tube. The exit end of the tube may have atomization capability useful in spray application of the reaction mixture. Alternatively, the fluid reaction mixture may be applied to a substrate as a bead. A static mix tube applicator is commercially available from Cammda Corporation.

The compressible coating layer of the present invention can be applied to a wide variety of substrates. Accordingly, the present invention is further directed to methods of coating substrates with the compressible coating layer described herein, and substrates coated thereby.

Non-limiting examples of suitable substrates can include but are not limited to metal, natural and/or synthetic stone, ceramic, glass, brick, cement, concrete, cinderblock, wood and composites and laminates thereof, wallboard, drywall, sheetrock, cement board, plastic, paper, PVC, styrofoam, plastic composites, acrylic composites, ballistic composites, asphalt, fiberglass, soil, gravel and the like. “Metallic substrate(s)” includes substrates comprising metal(s) and/or metal alloys, including but not limited to aluminum, any form of steel such as cold rolled steel, electrogalvanized steel, hot dipped galvanized steel, titanium and the like. Plastics can include but are not limited to TPO, SMC, TPU, polypropylene, polycarbonate, polyethylene, polyamides (Nylon). The substrates can be primed metal and/or plastic; that is, an organic or inorganic layer is applied thereto. Further, the coating compositions of the present invention can be applied to said substrates to impart one or more of a wide variety of properties such as but not limited to corrosion resistance, abrasion resistance, impact damage, flame and/or heat resistance, chemical resistance, UV light resistance, structural integrity, ballistic mitigation, blast mitigation, sound dampening, decoration and the like. In non-limiting examples, the coating compositions of the present invention can be applied to at least a portion of a building component or an article of manufacture such as but not limited to a vehicle. “Vehicle” includes but is not limited to civilian, commercial, and military land-, water-, and air-vehicles, for example, cars, trucks, boats, ships, submarines, airplanes, helicopters, humvees and tanks. Truck beds are suitable substrates; the coatings of the present invention can form at least a portion of the truck bed liners. The article of manufacture can be a building structure. “Building structure”, “building component” and like terms includes but is not limited to at least a portion of a structure including residential, commercial and military structures, for example, roofs, floors, support beams, walls and the like. As used herein, the term “substrate” may refer to a surface, either external or internal, on at least a portion of an article of manufacture, the article of manufacture itself, a building component and the like. In other specific embodiments, the substrate can comprise a portion of a piece of sporting equipment, such as a golf ball or golf club. “Building structure” also includes structures, including those that define apertures, associated with mining. Typical mine structures include mains, submains, gate road entries, production panels, bleeders and other active working areas associated with underground mining. Accordingly, the present compositions can also be used to coat mine supports, beams and the like and can be further used, alone or in conjunction with other layers, to seal and/or reinforce mine structures. A “portion” can be any amount of the substrate, including the whole substrate.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Thus, while the invention has been described in terms of “a” compressible coating layer, “a” film forming resin, and “a” thermoplastic additive, one or more of each of these can be used. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

Various polyurea cast samples were prepared using the acrylated amine curatives and isocyanate prepolymers indicated in the tables below. Generally, for each sample, approximately 80 grams of the isocyanate prepolymer were measured into a paper cup. The amine curative was measured into a FlackTek cup (FlackTek Inc., Landrum, S.C.) along with a STAN-TONE 10ET03 WHITE tint paste (available from Polyone Corporation), in some cases, CERAFLOUR organic pigments (available from Byk-Chemie), in some cases TINUVIN UVA's (available from Ciba Speciality Chemicals), and in some cases Dibutyl Tin Dilaurate. This mixture is referred to as “curative blend”, below. The curative blend was then placed into a FlackTek SpeedMixer (FlackTek SpeedMixer DAC 400FVZ, from FlackTek Inc.), and allowed to spin for 1 minute at 2,500 rpm.

The isocyanate prepolymer was placed in the microwave oven and heated for 15 seconds on high power. Immediately after the microwave oven stopped, the curative blend was placed in the oven, together with the isocyanate prepolymer, and heated for 15 seconds on high power. These two materials were then transferred to the degassing chamber, where both materials were degassed until minimal bubbling occurred in the two samples. Once minimal to no bubbling had occurred, the materials were transferred into the microwave for an additional heating for 15 seconds on high power.

The curative blend was placed on the balance (Mettler PG5002), tared, and the isocyanate prepolymer in the amount in grams indicated in the table below was added. This mixture was sealed with a lid and was then placed into the FlackTek SpeedMixer, and allowed to spin for 5 seconds at 2,500 rpm. The sample was immediately removed from the mixer, the lid was quickly removed, and the mixed sample was poured into the TEFLON mold cavity (6″×6″×⅛″), from Accrotool, Inc., New Kensington, Pa.).

The “Pour Time” was measured by a stopwatch. When the sample was placed in the mixer and started, the stopwatch was started. When the cast sample no longer flowed freely from the cup, the stopwatch was stopped. This gave a “Pour Time” range as shown in the tables below.

A flat metal lid covered with TEDLAR film (1.4 mil, from DuPont) was placed over the TEFLON cavity containing the polyurea casting. This mold assembly was then transferred to a Carver Press (Hydraulic Unite Model #3912, from Carver, Inc.) and heated to 150° F. Force between 10,000 lb. to 15,000 lb. was applied to the mold assembly. The sample was then cured for 15 minutes under these conditions. After 15 minutes, the Carver Press was opened, the mold assembly was removed, and the metal lid with the TEDLAR film was removed. An article of approximately 6 inches by 6 inches by ⅛ inch thick was removed from the TEFLON mold, and placed in a 150° F. electric oven for 120 minutes to complete curing.

After the sample was removed from the oven, the sample was allowed to equilibrate for greater than 12 hours. The sample hardness was measured by an Instron Shore D probe (Shore Instruments, Norwood, Mass.). Shore D was measured after 5 sec dwell time on the part.

The sample was measured for thermo-mechanical performance on a TMA 2940 Thermomechanical Analyzer (TA Instruments, New Castle, Del.). The test parameters were to start testing at 25° C., apply a temperature ramp of 10° C./min, and finish testing at 125° C. The applied force load was 0.7 lb_{force}. The initial softening point (“Ts”) is reported in the table below.

TABLE 1

| | 1 | 2 | 3 |
|---|---|---|---|
| Prepolymer | DESW/JEFFAMINE | DESW/JEFFAMINE | DESW/JEFFAMINE |
| | D2000 | D2000 | D2000 |
| | @ 8.75% NCO | @ 8.75% NCO | @ 8.75% NCO |
| NCO eq. Wt. | 481.143 | 481.143 | 481.143 |
| NCO:NH | 1.00:1.02 | 1.00:1.02 | 1.00:1.02 |
| Curative | 06-016-068 | 06-016-068 | 06-016-068 |
| Notebook Code | | | |
| Curative | 1eq DMDC/0.30eq | 1eq DMDC/0.30eq | 1eq DMDC/0.30eq |
| | HDDA/0.65eq methyl | HDDA/0.65eq methyl | HDDA/0.65eq methyl |
| | acrylate | acrylate | acrylate |
| Curative | 211 | 211 | 211 |
| Eq. Wt. | | | |
| Catalyst | 0.1% DBTDL | 0.1% DBTDL | 0.1% DBTDL |
| % HCC-19584 | 4.5 | 4.5 | 4.5 |
| Notebook | 06-022-76A-2 | 06-022-76C-2 | 06-022-76D-2 |
| Original | 3-15A-2 | 3-15C-2 | 3-15D-2 |
| Code # | | | |
| Additives | 0.0% Additive | 1% CERAFLOUR 970 | 1% CERAFLOUR 970 |
| | | 2% CERAFLOUR 994 | 2% CERAFLOUR 994 |
| | | 0.5% TINUVIN 328 | 1.0% TINUVIN 328 |
| Comments | | Slight film on surface | Nice viscosity, no firm on |
| | | | surface, maybe thicker in |
| | | | pouring |
| Isocyanate | 38.49 | 38.49 | 38.49 |
| Prepolymer | | | |
| (gms) | | | |
| Curative (gms) | 17.22 | 17.22 | 17.22 |
| VZ-42-6357 | 2.63 | 2.72 | 2.74 |
| Pigment (gms) | | | |
| Dibutyl Tin | 0.06 | 0.06 | 0.06 |
| Dilaurate (gms) | | | |
| Additive #1 | Control | CERAFLOUR 970 | CERAFLOUR 970 |
| Additive #1 | 0 | 0.61 | 0.61 |
| (gms) | | | |
| Additive #2 | | CERAFLOUR 994 | CERAFLOUR 994 |
| Additive #2 | | 1.21 | 1.22 |
| (gms) | | | |
| Additive #3 | | Tinuvin 328 | Tinuvin 328 |
| Additive #3 | | 0.3 | 0.61 |
| (gms) | | | |
| Pour Time/sec | 63 | 56.58 | 53.46 |
| Shore D | 59 | 55 | 52 |
| T(soft) Initial | 76 | Xxx | xxx |

| | 4 | 5 | 6 |
|---|---|---|---|
| Prepolymer | DESW/JEFFAMINE | DESW/JEFFAMINE | DESW/JEFFAMINE |
| | D2000 | D2000 | D2000 |
| | @ 8.75% NCO | @ 8.75% NCO | @ 8.75% NCO |
| NCO eq. Wt. | 481.143 | 481.143 | 481.143 |
| NCO:NH | 1.00:1.02 | 1.00:1.02 | 1.00:1.02 |
| Curative | 06-016-068 | 06-016-068 | 06-016-068 |
| Notebook Code | | | |
| Curative | 1eq DMDC/0.30eq | 1eq DMDC/0.30eq | 1eq DMDC/0.30eq |
| | HDDA/0.65eq methyl | HDDA/0.65eq methyl | HDDA/0.65eq methyl |
| | acrylate | acrylate | acrylate |
| Curative | 211 | 211 | 211 |
| Eq. Wt. | | | |
| Catalyst | 0.1% DBTDL | 0.1% DBTDL | 0.1% DBTDL |
| % HCC-19584 | 4.5 | 4.5 | 4.5 |
| Notebook | 06-022-76E-2 | 06-022-76F-2 | 06-022-76G-2 |
| Original | 3-15E-2 | 3-15F-2 | 3-15G-2 |
| Code # | | | |
| Additives | 3.0% CERAFLOUR 994 | 3.0% CERAFLOUR 994 | 3.0% CERAFLOUR 994 |
| | | 0.5% TINUVIN 328 | 1.0% TINUVIN 328 |
| Comments | Thick curative viscosity, | Thick curative viscosity/ | Nice pour |
| | but not pasty | good pour viscosity/nice | |
| | | pour | |
| Isocyanate | 38.49 | 38.49 | 38.49 |
| Prepolymer | | | |
| (gms) | | | |
| Curative (gms) | 17.22 | 17.22 | 17.22 |
| VZ-42-6357 | 2.71 | 2.72 | 2.74 |
| Pigment (gms) | | | |
| Dibutyl Tin | 0.06 | 0.06 | 0.06 |
| Dilaurate (gms) | | | |
| Additive #1 | CERAFLOUR 994 | CERAFLOUR 994 | CERAFLOUR 994 |
| Additive #1 | 1.81 | 1.82 | 1.83 |
| (gms) | | | |
| Additive #2 | | TINUVIN 328 | TINUVIN 328 |
| Additive #2 | | 0.3 | 0.61 |
| (gms) | | | |
| Additive #3 | | | |
| Additive #3 | | | |
| (gms) | | | |
| Pour Time/sec | 53.12 | 55.27 | 42.92 |
| Shore D | 50 | 50 | 50 |
| T(soft) Initial | 81 | 80 | xxx |

Additional examples were run using micronized amide wax (CERAFLOUR 994), polyethylene wax (CERAFLOUR 990), or PTFE modified polyethylene wax (CERAFLOUR 968). As can be seen in Table 2, below, the examples using the additive of the present invention (Examples 8 and 9) gave lower Shore D hardness vs. the Example 7 control.

TABLE 2

| | 7 | 8 | 9 | 10 |
|---|---|---|---|---|
| Prepolymer | DESW/JEFFAMINE | DESW/JEFFAMINE | DESW/JEFFAMINE | DESW/JEFFAMINE |
| | D2000 | D2000 | D2000 | D2000 |
| | @ 8.75% NCO | @ 8.75% NCO | @ 8.75% NCO | @ 8.75% NCO |
| NCO eq. Wt. | 481.14 | 481.14 | 481.14 | 481.14 |
| NCO:NH | 1.00:1.02 | 1.00:1.02 | 1.00:1.02 | 1.00:1.02 |
| Curative | 06-016-92 | 06-016-92 | 06-016-92 | 06-016-92 |
| Notebook Code | | | | |
| Curative | 1eq DMDC/0.30eq | 1eq DMDC/0.30eq | 1eq DMDC/0.30eq | 1eq DMDC/0.30eq |
| | HDDA/0.65eq methyl | HDDA/0.65eq methyl | HDDA/0.65eq methyl | HDDA/0.65eq methyl |
| | acrylate | acrylate | acrylate | acrylate |
| Curative | 211.00 | 211.00 | 211.00 | 211.00 |
| Eq. Wt. | | | | |
| Catalyst | 0.1% DBTDL | 0.1% DBTDL | 0.1% DBTDL | 0.1% DBTDL |
| % HCC-19684 | 4.5 | 4.5 | 4.5 | 4.5 |
| Notebook | 06-022-71A | 06-022-71B | 06-022-71C | 06-022-71D |
| Original | 11A | 11B | 11C | 11D |
| Code # | | | | |
| Additives | 0% Wax Additive | 3.0% CERAFLOUR 994 | 5.0% CERAFLOUR 994 | 3.0% CERAFLOUR 990 |
| Comments | | | Thick Curative | |
| Isocyanate | 38.49 | 38.49 | 38.49 | 38.49 |
| Prepolymer (gms) | | | | |
| Curative (gms) | 17.22 | 17.22 | 17.22 | 17.22 |
| VZ-42-6367 | 2.63 | 2.71 | 2.77 | 2.71 |
| Pigment (gms) | | | | |
| Dibutyl Tin | 0.06 | 0.06 | 0.06 | 0.06 |
| Dilaurate (gms) | | | | |
| Additives | Control | CERAFLOUR 994 | CERAFLOUR 994 | CERAFLOUR 990 |
| Additive (gms) | 0 | 1.81 | 3.08 | 1.81 |
| Pour Time/sec | 59.42 | 44.45 | 37.59 | 54.65 |
| Shore D | 59.0 | 52.0 | 51.8 | 55.6 |
| T(soft) Initial | 76 | 73 | 79 | 79 |

| | 11 | 12 | 13 |
|---|---|---|---|
| Prepolymer | DESW/JEFFAMINE | DESW/JEFFAMINE | DESW/JEFFAMINE |
| | D2000 | D2000 | D2000 |
| | @ 8.75% NCO | @ 8.75% NCO | @ 8.75% NCO |
| NCO eq. Wt. | 481.14 | 481.14 | 481.14 |
| NCO:NH | 1.00:1.02 | 1.00:1.02 | 1.00:1.02 |
| Curative | 06-016-92 | 06-016-92 | 06-016-92 |
| Notebook Code | | | |
| Curative | 1eq DMDC/0.30eq | 1eq DMDC/0.30eq | 1eq DMDC/0.30eq |
| | HDDA/0.65eq methyl | HDDA/0.65eq methyl | HDDA/0.65eq |
| | acrylate | acrylate | methyl acrylate |
| Curative | 211.00 | 211.00 | 211.00 |
| Eq. Wt. | | | |
| Catalyst | 0.1% DBTDL | 0.1% DBTDL | 0.1% DBTDL |
| % HCC-19684 | 4.5 | 4.5 | 4.5 |
| Notebook | 06-022-71E | 06-022-71F | 06-022-71G |
| Original | 11E | 11F | 11G |
| Code # | | | |
| Additives | 5.0% CRAFLOUR 990 | 3.0% CERAFLOUR 968 | 5.0% CERAFLOUR 968 |
| Comments | | | |
| Isocyanate | 38.49 | 38.49 | 38.49 |
| Prepolymer (gms) | | | |
| Curative (gms) | 17.22 | 17.22 | 17.22 |
| VZ-42-6367 | 2.77 | 2.71 | 2.77 |
| Pigment (gms) | | | |
| Dibutyl Tin | 0.06 | 0.06 | 0.06 |
| Dilaurate (gms) | | | |
| Additives | CERAFLOUR 990 | CERAFLOUR 968 | CERAFLOUR 968 |
| Additive (gms) | 3.08 | 1.81 | 3.08 |
| Pour Time/sec | 48.01 | 52.13 | 44.44 |
| Shore D | 56.1 | 54.8 | 54.0 |
| T(soft) Initial | 78 | 78 | 78 |

Whereas particular embodiments of this invention have been described above for purposes of illustration, it will be evident to those skilled in the art that numerous variations of the details of the present invention may be made without departing from the invention as defined in the appended claims.

Therefore, what is claimed is:

1. A compressible coating layer comprising:
a) a film forming resin; and
b) a thermoplastic additive dispersed throughout the film forming resin that maintains separate phase domains upon cure, wherein the film forming resin comprises polyurea and/or polyurethane and the thermoplastic additive comprises micronized amide wax.

2. The compressible coating layer of claim 1, wherein the coating layer has a dry film thickness of 8 mils or greater.

3. The compressible coating layer of claim 2, wherein the coating layer has a dry film thickness of 25 mils or greater.

4. The compressible coating layer of claim 2, wherein the coating layer has a dry film thickness of 50 mils or greater.

5. The compressible coating layer of claim 1, wherein the Shore D hardness of the layer is at least 50.

6. The compressible coating layer of claim 5, wherein the Shore D hardness of the layer is at least 60.

7. The compressible coating layer of claim 1, wherein the Shore D hardness of the layer is at least 50 and the Ts is >55° C.

8. The compressible coating layer of claim 1, wherein the coating comprises a polyurea formed from a reaction mixture comprising isocyanate and amine, wherein the ratio of equivalents of isocyanate groups to equivalents of amine groups is greater than 1 and the isocyanate and the amine can be applied to a substrate at a volume mixing ratio of 1:1.

9. The compressible coating layer of claim 1, wherein the thermoplastic additive has a melting point of 140-150° C.

10. The compressible coating layer of claim 1, wherein the coating layer is nonemissive.

11. The compressible coating of claim 1, wherein the thermoplastic additive has an average particle size of 4 to 5 microns.

12. A method of coating a substrate comprising applying to the substrate the compressible coating layer of claim 1.

13. The method of claim 12, wherein the substrate comprises at least a portion of a vehicle.

14. The method of claim 12, wherein substrate comprises at least a portion of a building structure.

15. The method of claim 12, wherein the substrate comprises a portion of a golf ball.

16. A golf ball comprising the coating layer of claim 1.

17. A truck bed liner comprising the coating layer of claim 1.

18. A building structure comprising the coating layer of claim 1.

19. The building structure of claim 18, wherein the structure comprises a mine structure.
